(19) United States
(12) Patent Application Publication
(10) Pub. No.: US 2019/0079784 A1
(43) Pub. Date: Mar. 14, 2019

(54) UI GENERATING APPARATUS

(71) Applicant: Olympus Corporation, Tokyo (JP)

(72) Inventors: Noriyuki Takeishi, Tokyo (JP); Hidenobu Kubo, Tokyo (JP)

(73) Assignee: Olympus Corporation, Tokyo (JP)

(21) Appl. No.: 16/191,520

(22) Filed: Nov. 15, 2018

Related U.S. Application Data
(63) Continuation of application No. PCT/JP2017/012514, filed on Mar. 28, 2017.

(30) Foreign Application Priority Data
May 20, 2016 (JP) 2016-101481

(51) Int. Cl. G06F 9/451; G06F 17/30

(52) U.S. Cl. CPC G06F 9/451; G06F 17/30247

(57) ABSTRACT

A user interface (UI) generating apparatus includes a processing portion and an application storage memory configured to store therein application programs to be executed for generating a UI screen by the processing portion. A parts storage memory separate from the application storage memory is configured to store therein parts data representing parts as components of the UI screen and an input interface through which rewriting parts data for the parts data stored in the parts storage memory can be input from external sources.

### CROSS-REFERENCE TO RELATED APPLICATIONS

This application is a continuation application of PCT Application No. PCT/JP2017/012514 filed on Mar. 28, 2017, which in turn claim priority to the Japanese Patent Application No. 2016-101481 filed on May 20, 2016 in Japan which is hereby incorporated by reference in its entirety.

### TECHNICAL FIELD

The technology disclosed herein generally relates to a user interface (UI) generating apparatus for generating a UI screen.

### DESCRIPTION OF THE RELATED ART

Heretofore, there have been known apparatus for generating, displaying, or otherwise dealing with UI screens.

For example, there has been known in the medical field a system for generating, displaying, or otherwise dealing with a graphical user interface (GUI) screen as disclosed in US Patent Application Publication No. 2014/0187856. The system displays a GUI screen including a plurality of icons, and the user can make settings of an apparatus connected thereto, browse patient data, and otherwise take action through the displayed GUI screen.

Generally, the apparatus for generating or otherwise dealing with UI screens being described hereinbefore, a UI screen is generated by a software, and parts data representing parts such as images or icons, and characters, etc. that represent components of the UI screen are incorporated as part of the software. Therefore, when parts representing components of the UI screen are to be changed or replaced, it is necessary to update the software even if the algorithm of the software does not need to be changed. It has thus not been easy to change parts representing components of UI screens.

Accordingly, there is a need to provide a UI generating apparatus that makes it easy to change parts representing components of UI screens.

### BRIEF SUMMARY OF EMBODIMENTS

According to a first aspect of the disclosed technology, there is provided a user interface (UI) generating apparatus including an application storage memory configured to store therein an application program to be executed for generating a UI screen. A parts storage memory separates from the application storage memory is configured to store therein parts data containing parts representing components of the UI screen and identifications as information that uniquely identifies the parts. An input interface through which rewriting parts data containing rewriting parts for rewriting the parts is stored in the parts storage memory and the identifications is added to the rewriting parts are input from an external source. A processing portion is configured to search the parts data stored in the parts storage memory for parts data containing an identification that is the same as the identification added to a rewriting part input through the input interface, as a target to be rewritten by the rewriting part input through the input interface.

According to a second aspect of the disclosed technology, the processing portion generates the UI screen by executing the application program stored in the application storage memory, based on the parts data stored in the parts storage memory after the parts data stored in the parts storage memory has been rewritten into the rewriting parts data input through the input interface.

According to a third aspect of the disclosed technology, the parts data stored in the parts storage memory and the rewriting parts data input through the input interface each have head data containing the identification and a data size of the parts data.

According to a fourth aspect of the disclosed technology, each of the parts data stored in the parts storage memory is rewritten into rewriting parts data input through the input interface by acquiring an identification contained in head data of the rewriting parts data input through the input interface, comparing the acquired identification with an identification table of the parts data stored in the parts storage memory, if the acquired identification is contained in the identification table, comparing a data size contained in the head data of the rewriting parts data whose head data contains the acquired identification with a data area size secured for the parts data stored in the parts storage memory which has the head data containing the acquired identification, if the data size contained in the head data of the rewriting parts data is equal to or smaller than the data area size, rewriting the parts data stored in the parts storage memory which has the head data containing the acquired identification into the rewriting parts data whose head data contains the acquired identification, and if the acquired identification is not contained in the identification table or if the data size contained in the head data of the rewriting parts data is larger than the data area size, not rewriting the parts data stored in the parts storage memory which has the head data containing the acquired identification into the rewriting parts data whose head data contains the acquired identification.

According to a fifth aspect of the disclosed technology, the parts data are data representing images or characters as components of the UI screen.

The disclosed technology is advantageous in that it is easy to change parts representing components of UI screens.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a diagram illustrating a configurational example of a processor for use with an endoscope, to which a UI generating apparatus according to an embodiment is applied.

FIG. 2 is a diagram illustrating a data structure example of parts data stored in a parts memory.

FIG. 3 is a diagram illustrating a data structure example of updating parts data stored in an USB memory or the like.

FIG. 4 is a flowchart illustrating an example of an operation sequence for the processor for use with an endoscope to update parts data stored in the parts memory.

### DETAILED DESCRIPTION OF THE EMBODIMENTS

In the following description, various embodiments of the technology will be described. For purposes of explanation, specific configurations and details are set forth in order to provide a thorough understanding of the embodiments. However, it will also be apparent to one skilled in the art that the technology disclosed herein may be practiced without the specific details. Furthermore, well-known features may be omitted or simplified in order not to obscure the embodiment being described.

An embodiment of the disclosed technology will be described hereinafter with reference to the drawings.

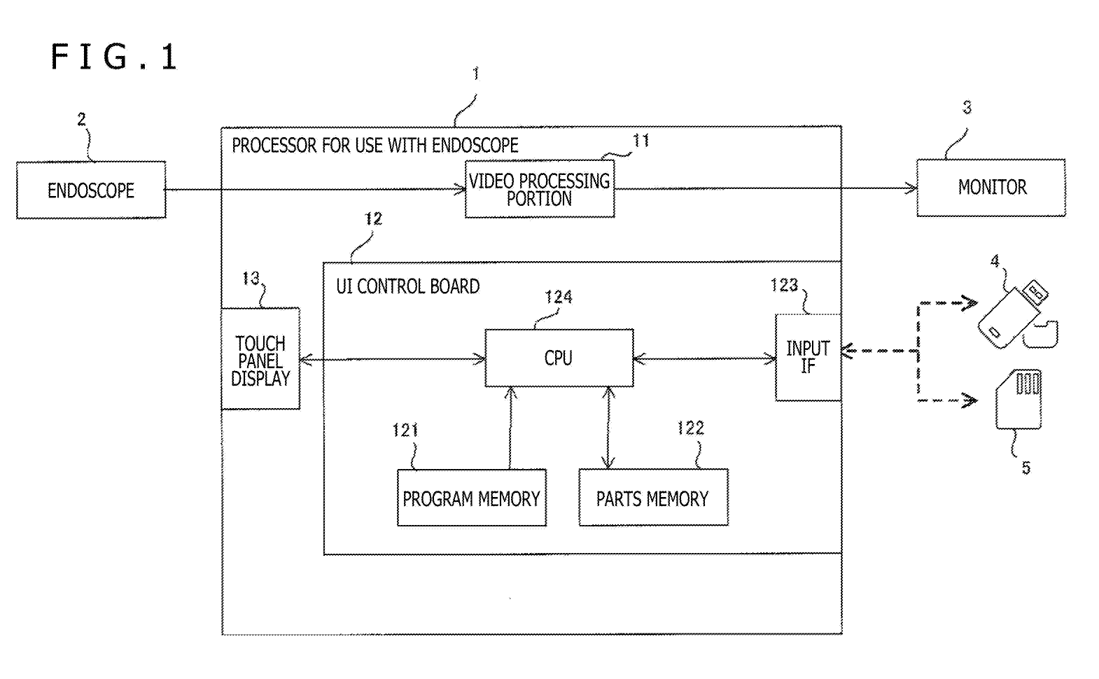

FIG. 1 is a diagram illustrating a configurational example of a processor for use with an endoscope, to which a UI generating apparatus is applied. The processor for use with an endoscope is an apparatus used in endoscopic examinations or the like at a medical organization such as a hospital, and is also referred to as an endoscopic apparatus, an endoscopic image processing apparatus, or the like.

As depicted in FIG. 1, the processor 1 for use with an endoscope includes a video processing portion 11, a UI control board 12, and a touch panel display 13. An endoscope 2 and a monitor 3 are connected to the processor 1. The video processing portion 11 generates a video signal based on an image signal acquired by the endoscope 2 that captures images of the inside of a body cavity in a patient and outputs the video signal to the monitor 3. The monitor 3 displays a video image based on the video signal. The UI control board 12 includes a program memory 121, a parts memory 122, an input interface (IF) 123, and a central processing unit (CPU) 124.

The program memory 121 stores or records therein application programs for generating a UI screen, etc. The parts memory 122 stores therein parts data of parts that represent components of the UI screen. The parts memory 122 is separate from the program memory 121. The input IF 123 is an interface (IF) through which updating parts data for the parts data stored in the parts memory 122 are input from external sources. For example, the input interface (IF) 123 is an interface (IF) to which a universal serial bus (USB) memory 4, a secure digital (SD) memory card 5, or the like that stores the updating parts data therein can be connected.

The CPU 124 controls various types of operation. For example, the CPU 124 changes or rewrites the parts data stored in the parts memory 122 to the updating parts data stored in the USB memory 4 or the like that is connected to the input interface (IF) 123. For example, moreover, the CPU 124 generates a UI screen to be displayed on the touch panel display 13 using the parts data stored in the parts memory 122 by executing the application programs stored in the program memory 121. The touch panel display 13 displays the UI screen generated by the CPU 124 and receives various inputs from the user through the displayed UI screen.

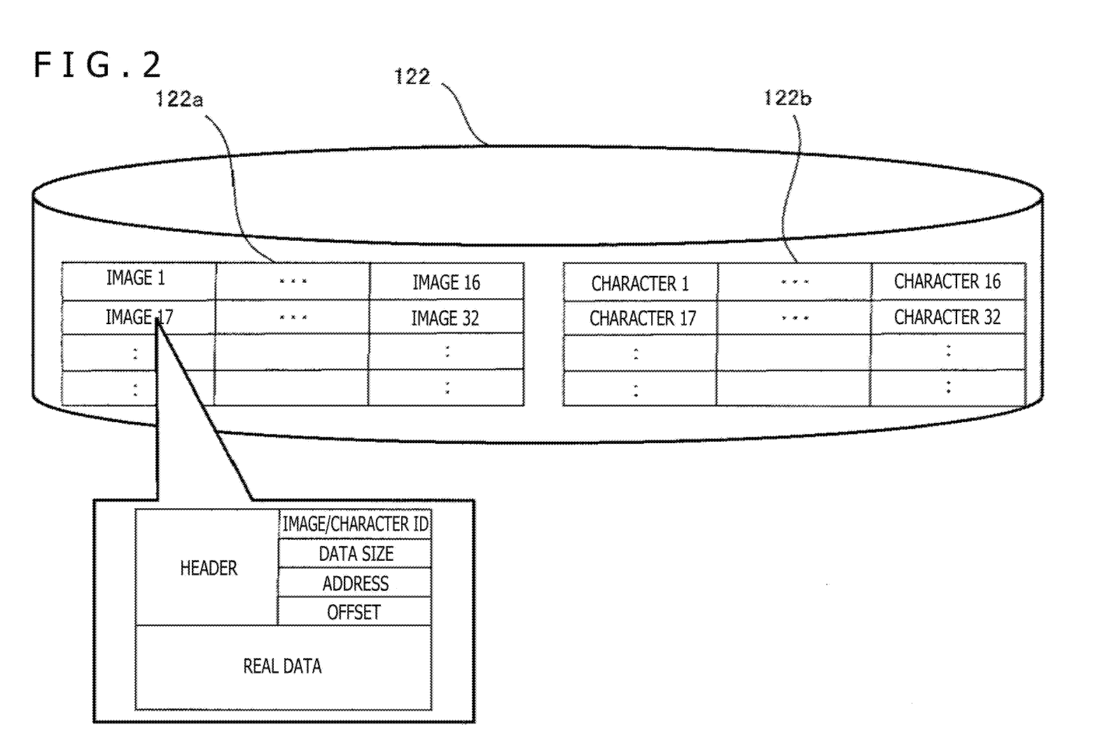

FIG. 2 is a diagram illustrating a data structure example of the parts data stored in the parts memory 122. As illustrated in FIG. 2, the parts memory 122 has parts storage tables 122a and 122b for storing the parts data. The parts storage table 122a is a table for storing therein image data (see “IMAGE 1,” etc. in FIG. 2) representing images such as icons, as parts data. The parts storage table 122b is a table for storing therein character data (see “CHARACTER 1,” etc. in FIG. 2) representing characters, as parts data. Each of the parts data stored in each of the parts storage tables 122a and 122b has real data of the parts data itself and header data (hereinafter referred to simply as “header”) as information regarding the parts data.

The header contains a parts identification (ID), a data size, an address, and an offset. The parts ID represents the ID of the parts data. If the parts data are image data, then the parts ID thereof is also referred to as image ID, and if the parts data are character data, then the parts ID thereof is also referred to as character ID. The data size represents the size of the real data of the parts data. The address represents the address on the parts memory 122 where the real data of the parts data is stored. The offset represents a value calculated by subtracting the data size of the parts data from a prescribed maximum allowable real data size for the parts data.

According to the present embodiment, since each of the parts data has such a header structure, an area having a size represented by the sum of the data size and the offset contained in the header of the parts data, i.e., an area having the prescribed maximum allowable real data size for the parts data, is secured as an area for storing therein the real data of the parts data, from the address contained in the header of the parts data. Consequently, as will be described hereinafter with reference to FIG. 4, even if certain parts data to be changed or rewritten has different sizes before and after the change, the parts data can be changed providing the size of the changed parts data is equal to or smaller than the maximum allowable real data size.

The maximum allowable real data size may be the same for all the parts data or may be different from parts data to parts data. Alternatively, the maximum allowable real data size may be the same for a plurality of parts data, e.g., may be the same for parts data representing image data or may be the same for parts data representing character data.

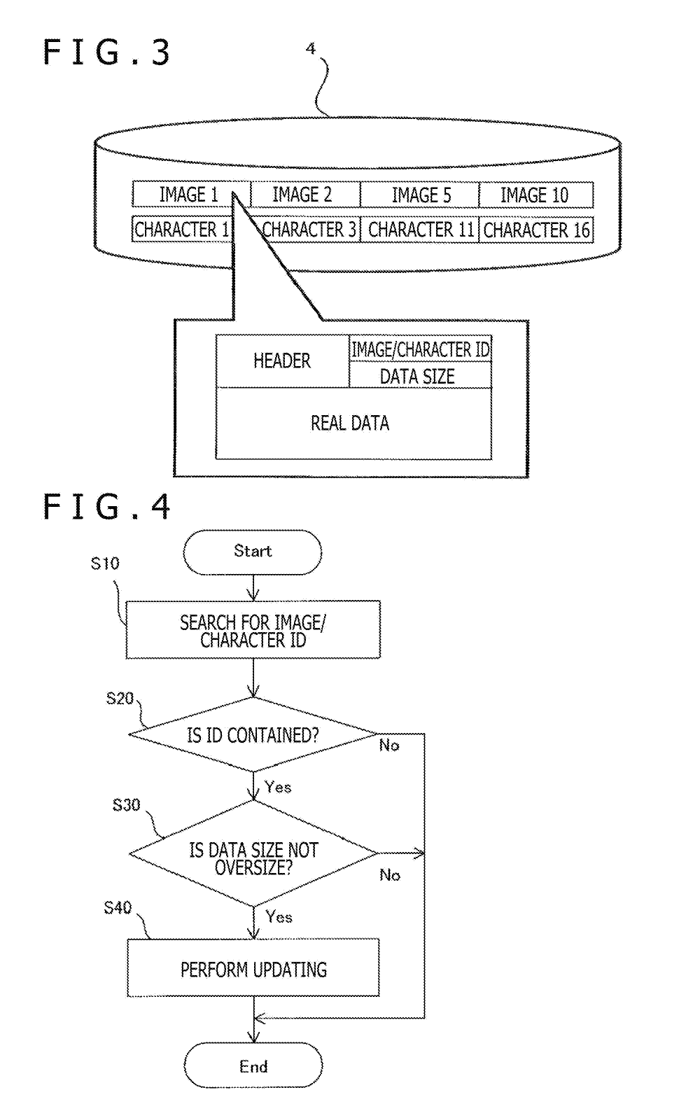

FIG. 3 is a diagram illustrating a data structure example of the updating parts data stored in the USB memory 4 or the like. As depicted in FIG. 3, each of the updating parts data stored in the USB memory 4 or the like has real data of the updating parts data itself and a header as information regarding the updating parts data. The header contains a parts ID and a data size. The parts ID represents the ID of the updating parts data. If the updating parts data is updating parts data for the parts data stored in the parts memory 122, then the parts ID of the updating parts data is the same as the parts ID of the parts data stored in the parts memory 122. The data size represents the size of the real data of the updating parts data.

In the processor 1 thus configured for use with an endoscope, the CPU 124 is an example of processing portion. The program memory 121 is an example of application storage memory for storing therein application programs to be executed by the processing portion for generating a UI screen. The parts memory 122 is an example of parts storage memory, which is separate from the application storage memory, for storing therein parts data representing parts as components of the UI screen. The input IF 123 is an example of input interface through which parts data for rewriting the parts data stored in the parts storage memory are input from external sources. The ID is an example of identification. The updating parts data are an example of rewriting parts data. The parts storage tables 122a and 122b are an example of identification tables for the parts data stored in the parts storage memory. The prescribed maximum allowable real data size for the parts data is an example of data area size secured for the parts data.

Next, operation of the processor 1 for use with an endoscope at the time it updates the parts data stored in the parts memory 122 will be described hereinafter.

FIG. 4 is a flowchart illustrating an example of operation sequence of the processor 1 for use with an endoscope.

As depicted in FIG. 4, when the CPU 124 detects that the USB memory 4 or the like is connected to the input IF 123, the CPU 124 searches for a parts ID, i.e., an image ID or a character ID, contained in the header of the updating parts data stored in the USB memory 4 or the like in step S10.

Then, the CPU 124 performs the processing of steps S20 through S40 on the parts ID searched for in step S10. If a plurality of updating parts data is stored in the USB memory 4 or the like, then since the CPU 124 searches for a plurality of parts IDs, the CPU 124 performs the processing of steps S20 through S40 on those parts IDs.

Specifically, the CPU 124 regards one of the parts IDs that have not been specified as processing target parts IDs among the parts IDs searched for in step S10, as a processing target parts ID, and determines whether or not the processing target parts ID is contained in the headers of the parts data stored in the parts storage tables 122a and 122b of the parts memory 122 in step S20.

If the determined result in step S20 is Yes, then the CPU 124 determines whether or not the data size contained in the header of updating parts data whose header contains the processing target parts ID is equal to or smaller than the size represented by the sum of the data size and the offset contained in the header of the parts data whose header contains the processing target parts ID, stored in the parts memory 122, i.e., the maximum allowable real data size in step S30.

If the determined result in step S30 is Yes, then the CPU 124 updates the parts data whose header contains the processing target parts ID, stored in the parts memory 122, into the updating parts data whose header contains the processing target parts ID in step S40. According to this updating process, the real data of the parts data stored in the parts memory 122 is rewritten into the real data of the updating parts data. The data size and the offset contained in the header of the parts data stored in the parts memory 122 are rewritten depending on the data size contained in the header of the updating parts data.

If the determined result in step S20 is No or if the determined result in step S30 is No, then the CPU 124 does not update the parts data into the updating parts data whose header contains the processing target parts ID.

If the determined result in step S20 is No or if the determined result in step S30 is No or after step S40, then, although not illustrated, in case there remain parts IDs that have not been specified as processing target parts IDs among the parts IDs searched for in step S10, the processing goes back to step S20, and in case there remain no such parts IDs, the processing sequence comes to an end.

After the processing sequence has ended, the CPU 124 generates a UI screen based on the parts data updated as described hereinbefore that are stored in the parts memory 122, and controls the touch panel display 13 to display the generated UI screen.

According to the present embodiment, as described hereinbefore, the parts data stored in the parts memory 122 can be updated simply when the USB memory 4 or the like that stores the updating parts data is connected to the input interface (IF) 123. Therefore, when parts representing components of a UI screen are to be changed, it is not necessary to perform the conventional software updating process, but the parts representing components of a UI screen can easily be changed. The user can immediately confirm the changed parts by confirming the UI screen displayed on the touch panel display 13.

In sum, the disclosed technology is directed to a user interface (UI) generating apparatus comprises an application storage memory configured to store therein an application program to be executed for generating a UI screen. A parts storage memory being separate from the application storage memory, is configured to store therein parts data containing parts representing components of the UI screen and identifications as information that uniquely identifies the parts. An input interface through which rewriting parts data containing rewriting parts for rewriting the parts stored in the parts storage memory and the identifications added to the rewriting parts are input from an external source. A processing portion is configured to search the parts data stored in the parts storage memory for parts data containing an identification that is the same as the identification added to the rewriting parts data input through the input interface as a target to be rewritten by the rewriting parts data input through the input interface.

The processing portion generates the UI screen by executing the application program stored in the application storage memory based on the parts data stored in the parts storage memory after the parts data stored in the parts storage memory has been rewritten into the rewriting parts data input through the input interface. The parts data stored in the parts storage memory and the rewriting parts data input through the input interface each have head data containing the identification and a data size of the parts data. Each of the parts data stored in the parts storage memory is rewritten into rewriting parts data input through the input interface by acquiring an identification contained in head data of the rewriting parts data input through the input interface and comparing the acquired identification with an identification table of the parts data stored in the parts storage memory. If the acquired identification is contained in the identification table, comparing a data size contained in the head data of the rewriting parts data whose head data contains the acquired identification with a data area size secured for the parts data stored in the parts storage memory which has the head data containing the acquired identification.

If the data size contained in the head data of the rewriting parts data is equal to or smaller than the data area size, rewriting the parts data stored in the parts storage memory which has the head data containing the acquired identification into the rewriting parts data whose head data contains the acquired identification. If the acquired identification is not contained in the identification table or if the data size contained in the head data of the rewriting parts data is larger than the data area size, not rewriting the parts data stored in the parts storage memory which has the head data containing the acquired identification into the rewriting parts data whose head data contains the acquired identification. The parts data are data representing images or characters as components of the UI screen.

Another aspect of the disclosed technology is directed to a user interface (UI) generating apparatus comprises an application storage memory configured to store therein an application program to be executed for generating a UI screen. A parts storage memory, being separate from the application storage memory, is configured to store therein parts data containing parts representing components of the UI screen and identifications as information that uniquely identifies the parts. An input interface through which rewriting parts data containing rewriting parts for rewriting the parts stored in the parts storage memory and the identifications added to the rewriting parts are input from an external source. A processing portion configured to search the parts data stored in the parts storage memory for parts data containing an identification that is the same as the identification added to a rewriting part input through the input interface as a target to be rewritten by the rewriting part input through the input interface and wherein the parts data stored in the parts storage memory and the rewriting parts data input through the input interface each have head data containing the identification and a data size of the parts data and wherein each of the parts data stored in the parts storage memory is rewritten into rewriting parts data input through the input interface by acquiring an identification contained in head data of the rewriting parts data input through the input interface and comparing the acquired identification with an identification table of the parts data stored in the parts storage memory.

If the acquired identification is contained in the identification table, comparing a data size contained in the head data of the rewriting parts data whose head data contains the acquired identification with a data area size secured for the parts data stored in the parts storage memory which has the head data containing the acquired identification.

If the data size contained in the head data of the rewriting parts data is equal to or smaller than the data area size, rewriting the parts data stored in the parts storage memory which has the head data containing the acquired identification into the rewriting parts data whose head data contains the acquired identification; and

if the acquired identification is not contained in the identification table or if the data size contained in the head data of the rewriting parts data is larger than the data area size, not rewriting the parts data stored in the parts storage memory which has the head data containing the acquired identification into the rewriting parts data whose head data contains the acquired identification.

The processing portion generates the UI screen by executing the application program stored in the application storage memory based on the parts data stored in the parts storage memory after the parts data stored in the parts storage memory has been rewritten into the rewriting parts data input through the input interface.

A further aspect of the disclosed technology is directed to a method for generating user interface comprises

storing an application program to be executed for generating a user interface screen;

storing a first parts data containing a first identifications, the first parts data representing components of the user interface screen;

inputting a second parts data containing a second identification;

searching the first parts data and extracting one of the first parts data containing the second identification; and

rewriting the one of the first parts data into the second parts data.

In the present embodiment, the parts data and the updating parts data therefor may be parts data representing parts other than images such as icons or the like and characters and updating parts data for such parts data.

The embodiment described hereinbefore illustrates a specific example of the present disclosure for an easy understanding of the disclosed technology, and the present disclosure is not limited to the embodiment described hereinbefore. Various changes and modifications may be made with respect to the present invention without departing from the scope of the invention as defined by the appended claims.

While various embodiments of the disclosed technology have been described above, it should be understood that they have been presented by way of example only, and not of limitation. Likewise, the various diagrams may depict an example schematic or other configuration for the disclosed technology, which is done to aid in understanding the features and functionality that can be included in the disclosed technology. The disclosed technology is not restricted to the illustrated example schematic or configurations, but the desired features can be implemented using a variety of alternative illustrations and configurations. Indeed, it will be apparent to one of skill in the art how alternative functional, logical or physical locations and configurations can be implemented to implement the desired features of the technology disclosed herein.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary schematics, block diagrams, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular configuration.

### NUMERICAL REFERENCES LIST

1 Processor for use with endoscope
2 Endoscope
3 Monitor
4 USB memory
5 SD memory card
11 Video processing portion
12 UI control board
13 Touch panel display
121 Program memory
122 Parts memory
122a, 122b Parts storage table
123 Input IF
124 CPU

What is claimed is:

1. A user interface (UI) generating apparatus comprising:
an application storage memory configured to store therein an application program to be executed for generating a UI screen;
a parts storage memory, separate from the application storage memory, being configured to store therein parts data containing parts representing components of the UI screen and identifications as information that uniquely identifies the parts;
an input interface through which rewriting parts data containing rewriting parts for rewriting the parts stored in the parts storage memory and the identifications added to the rewriting parts are input from an external source; and
a processing portion configured to search the parts data stored in the parts storage memory for parts data containing an identification that is the same as the identification added to the rewriting parts data input through the input interface as a target to be rewritten by the rewriting parts data input through the input interface.

2. The UI generating apparatus of claim 1, wherein the processing portion generates the UI screen by executing the application program stored in the application storage memory based on the parts data stored in the parts storage memory after the parts data stored in the parts storage memory has been rewritten into the rewriting parts data input through the input interface.

3. The UI generating apparatus of claim 1, wherein the parts data stored in the parts storage memory and the rewriting parts data input through the input interface each have head data containing the identification and a data size of the parts data.

4. The UI generating apparatus of claim 3, wherein each of the parts data stored in the parts storage memory is rewritten into rewriting parts data input through the input interface by:
acquiring an identification contained in head data of the rewriting parts data input through the input interface;
comparing the acquired identification with an identification table of the parts data stored in the parts storage memory;
if the acquired identification is contained in the identification table, comparing a data size contained in the head data of the rewriting parts data whose head data contains the acquired identification with a data area size secured for the parts data stored in the parts storage memory which has the head data containing the acquired identification;
if the data size contained in the head data of the rewriting parts data is equal to or smaller than the data area size, rewriting the parts data stored in the parts storage memory which has the head data containing the acquired identification into the rewriting parts data whose head data contains the acquired identification; and
if the acquired identification is not contained in the identification table or if the data size contained in the head data of the rewriting parts data is larger than the data area size, not rewriting the parts data stored in the parts storage memory which has the head data containing the acquired identification into the rewriting parts data whose head data contains the acquired identification.

5. The UI generating apparatus of claim 1, wherein the parts data are data representing images or characters as components of the UI screen.

6. A user interface (UI) generating apparatus comprising:
an application storage memory configured to store therein an application program to be executed for generating a UI screen;
a parts storage memory, separate from the application storage memory, being configured to store therein parts data containing parts representing components of the UI screen and identifications as information that uniquely identifies the parts;
an input interface through which rewriting parts data containing rewriting parts for rewriting the parts stored in the parts storage memory and the identifications added to the rewriting parts are input from an external source; and
a processing portion configured to search the parts data stored in the parts storage memory for parts data containing an identification that is the same as the identification added to a rewriting part input through the input interface as a target to be rewritten by the rewriting part input through the input interface and wherein the parts data stored in the parts storage memory and the rewriting parts data input through the input interface each have head data containing the identification and a data size of the parts data and wherein each of the parts data stored in the parts storage memory is rewritten into rewriting parts data input through the input interface by:
acquiring an identification contained in head data of the rewriting parts data input through the input interface;
comparing the acquired identification with an identification table of the parts data stored in the parts storage memory;
if the acquired identification is contained in the identification table, comparing a data size contained in the head data of the rewriting parts data whose head data contains the acquired identification with a data area size secured for the parts data stored in the parts storage memory which has the head data containing the acquired identification;
if the data size contained in the head data of the rewriting parts data is equal to or smaller than the data area size, rewriting the parts data stored in the parts storage memory which has the head data containing the acquired identification into the rewriting parts data whose head data contains the acquired identification; and
if the acquired identification is not contained in the identification table or if the data size contained in the head data of the rewriting parts data is larger than the data area size, not rewriting the parts data stored in the parts storage memory which has the head data containing the acquired identification into the rewriting parts data whose head data contains the acquired identification.

7. The UI generating apparatus of claim 6, wherein the processing portion generates the UI screen by executing the application program stored in the application storage memory based on the parts data stored in the parts storage memory after the parts data stored in the parts storage memory has been rewritten into the rewriting parts data input through the input interface.

8. A method for generating user interface comprising:
storing an application program to be executed for generating a user interface screen;
storing a first parts data containing a first identifications, the first parts data representing components of the user interface screen;
inputting a second parts data containing a second identification;
searching the first parts data and extracting one of the first parts data containing the second identification; and
rewriting the one of the first parts data into the second parts data.
